(19) United States
(12) Patent Application Publication
(10) Pub. No.: US 2005/0223131 A1
(43) Pub. Date: Oct. 6, 2005

(54) Context-based direct memory access engine for use with a memory system shared by devices associated with multiple input and output ports

(76) Inventors: Kenneth S. Goekjian, Candia, NH (US); Raymond D. Cacciatore, Westford, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/817,207

(22) Filed: Apr. 2, 2004

(51) Int. Cl. G06F 13/28

(52) U.S. Cl. 710/22

(57) ABSTRACT

A direct memory access (DMA) system provides a single context-based DMA engine connected to the memory system. The context-based DMA Engine implements the logic for each DMA function only once, and switches parameter sets as needed to service various DMA requests from different channels. Arbitration is performed at the DMA request level. After a DMA channel is selected for service, the parameters for that channel's transfer are retrieved from a central context block, the data transfer is queued to the memory system, and the parameters are updated and stored back to the central context block. Data paths also are constructed to support context-based transfer, using buffer blocks, to allow the DMA engine and the memory system to access any channel's data through simple addressing of the buffer block. A buffer control unit allows independent flow control between write and read DMA channels accessing the same data, preventing underflow or overflow of data during simultaneous DMA operations.

### BACKGROUND

A direct memory access (DMA) system typically includes multiple DMA engines that access a central memory system. Because only one DMA engine may access the memory at a time, access to the memory is arbitrated. If multiple DMA engines are trying to transfer data at the same time, each DMA engine will wait for the other DMA engines to finish their transfers, introducing latency. In addition, the arbitration system typically has multiplexers to select which DMA engine's data and address will be sent to the central memory system.

A particularly desirable function in a DMA system with multiple channels is the ability to pass data in a buffer from one DMA channel to another DMA channel through the memory. Generally, the application must wait for the originating DMA channel to finish its transfer before starting the DMA channel that wants to use the data, which imposes significant latency.

### SUMMARY

A direct memory access (DMA) system overcomes these problems by providing a single context-based DMA engine connected to the memory system. The context-based DMA Engine implements the logic for each DMA function only once, and switches parameter sets as needed to service various DMA requests from different channels. Arbitration is performed at the DMA request level. After a DMA channel is selected for service, the parameters for that channel's transfer are retrieved from a central context block, the data transfer is queued to the memory system, and the parameters are updated and stored back to the central context block. Data paths also are constructed to support context-based transfer, using buffer blocks, to allow the DMA engine and the memory system to access any channel's data through simple addressing of the buffer block.

The DMA system also may have a buffer control unit (BCU) that permits DMA channels to be linked together in a flow controlled system to reduce latency. The buffer control unit allows independent flow control between write and read DMA channels accessing the same data, preventing underflow or overflow of data during simultaneous DMA operations. In particular, the large shared memory may be divided into several buffers. Buffers may be software-defined ring buffers of different sizes. A resource of the BCU is allocated to each of the buffers. DMA operations to or from a buffer are then linked to the BCU resource for that buffer. The BCU resource tracks the amount of data in the buffer and other buffer state information, and flow-controls the DMA engine(s) appropriately based on parameters that are set up within the BCU resource. Multiple read or write DMA channels also may be linked by the same BCU, so that, for example, two DMA channels could write into one buffer, which in turn is read out by one DMA channel that uses the data from both the input channels. To control data flow, neither the sender nor the receiver requires any knowledge of each other. The sender and receiver each use knowledge of the BCU resource associated with the buffer being used by the given DMA channel.

### BRIEF DESCRIPTION OF THE DRAWINGS

In the drawings,

FIG. 1 is a block diagram of an example system with multiple input and output ports accessing a memory using a context-based direct memory access engine.

FIG. 2 illustrates how the memory of FIG. 1 is configured to have multiple buffers, each of which is associated with a buffer control unit.

FIG. 3 illustrates a typical operation on video data using multiple buffers such as in FIG. 2.

FIG. 4 is a more detailed block diagram of an example implementation of the DMA controller and write data paths.

FIG. 5 is a more detailed block diagram of an example implementation of the DMA controller and read data paths.

FIG. 6 is an example block diagram of a buffer control unit.

FIG. 7 is an example implementation diagram of a state machine describing how the DMA engine may operate.

### DETAILED DESCRIPTION

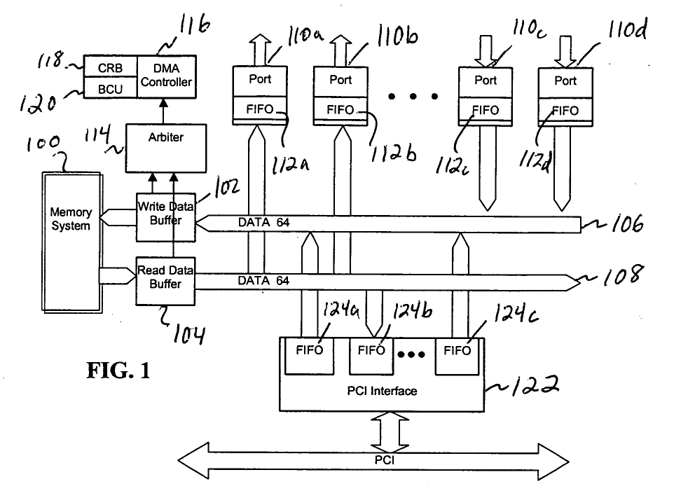

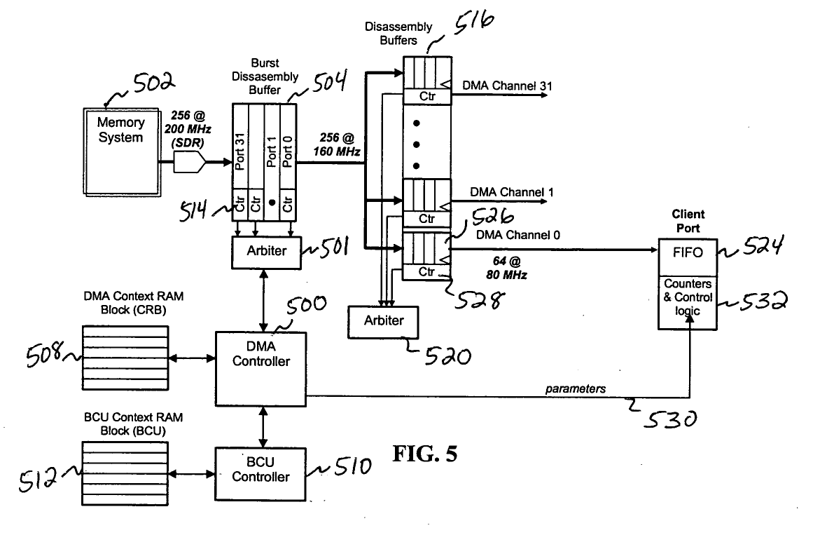

FIG. 1 is a block diagram of an example system with multiple input and output ports accessing a memory using a context-based direct memory access engine. It includes a memory system 100 that is accessed through a write data buffer 102 and a read data buffer 104. The memory system may include a large SDRAM and its own SDRAM controller. The memory system may operate in its own separate clock domain, in which case the memory controller includes a buffer or asynchronous FIFO that queues requests for transferring data to and from the memory. The write and read data buffers 102 and 104 are accessed by ports through a write data path 106 and read data path 108, respectively. These buffers and data paths are described in more detail in connection with FIGS. 4 and 5. Multiple devices (shown as ports 110a-110d) may access the memory system by connecting to the data paths 106 and 108. Each port (or channel) has its respective context information that is used by the DMA controller 116 to set up DMA transfers between the memory system and the write and read data buffers. Each channel in turn transfers data between the write and read data buffers and the channel's own memory (shown as FIFOs 112a-112d), with no intervention from the DMA controller. The DMA controller provides the parameters to the SDRAM controller for access between the write and read data buffers and the memory; the SDRAM controller has direct control of one side of the write and read data buffers. A memory arbiter 114 tracks these accesses, and in turn generates requests (with the associated channel number) to the DMA controller 116. The DMA controller accesses a DMA context RAM block (CRB) 118, for DMA context information for each request's channel, and a buffer control unit (BCU) 120, for state information about the buffers allocated in the memory. In general, the memory arbiter and DMA controller try to maintain read buffers as full as possible and try to maintain write buffers as empty as possible.

This system may be implemented as a peripheral device connected to a host computer through a standard interface such as a PCI interface 122. The PCI interface may include one or more channels as indicated by FIFOs 124a, 124b and 124c. An application executed on the host computer configures the buffers in the memory system 100, and their corresponding BCUs, and sets up DMA contexts to be used by the DMA controller 116.

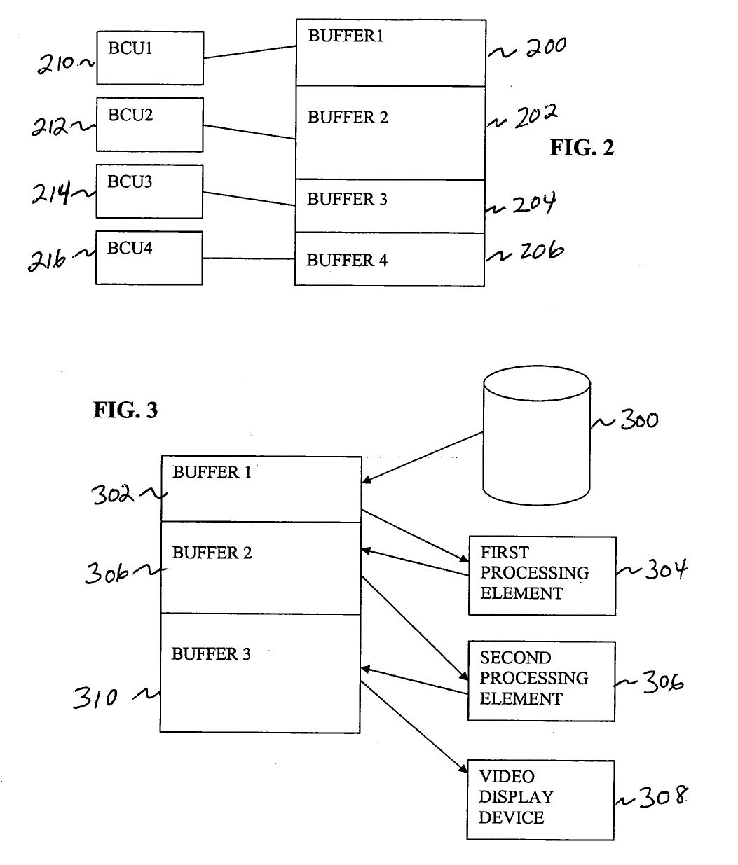

FIG. 2 illustrates how the memory of FIG. 1 may be configured to have multiple buffers, each of which is associated with a buffer control unit. FIG. 2 shows four (4) buffers 200, 202, 204 and 206, each of which may be a different size. Each buffer typically is used as a first-in, first-out ring buffer, and thus has state information such as the current read and write pointers and other information. Buffers may be defined by applications software executed on a host computer connected to a peripheral card that includes this DMA system. A buffer control unit entry, or BCU element, (210, 212, 214, 216) may be associated with each of the buffers. A buffer control unit entry associated with a buffer is defined by a set of registers stored in memory that represent state information and parameters associated with the buffer. Buffer control units are particularly useful where buffers are implemented as ring buffers and are used in different stages of a set of processing operations, in which case state information will include at least the current read and write pointers.

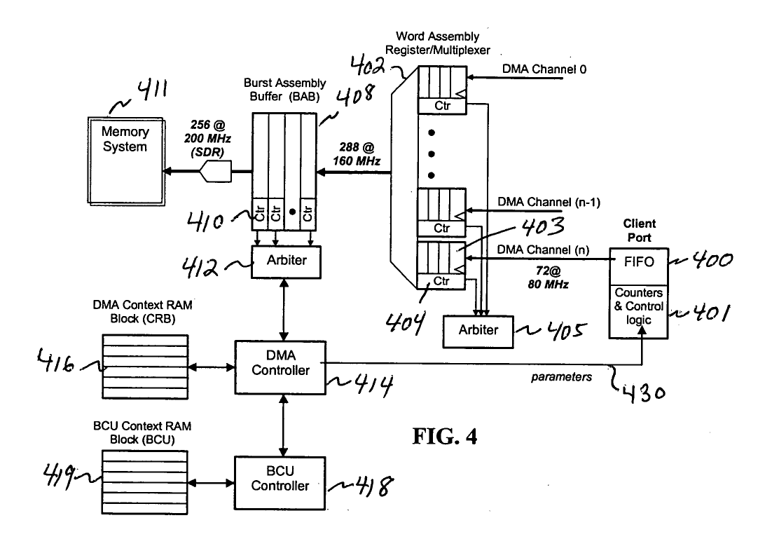

FIG. 3 illustrates an example data flow for a video processing operation performed using the buffers in the memory system accessed using such a DMA system. First, data is read from storage 300 into a first buffer 302 through the write data path. That data is read from the first buffer 302 and provided over the read data path to a first processing element 304, which may perform any of a variety of data processing operations. The output of the first processing element is written into a second buffer 306 in the memory over the write data path. Data is then read from this second buffer and provided over the read data path to a second processing element 308 which may perform any of a variety of data processing operations. The output of the second processing element is written into a third buffer 310 in the memory over the write data path. Finally, the data is read from the third buffer 310 and is provided over the read data path to an output device, such as a video display device 312. The DMA system described herein makes efficient the data transfers performed in this kind of processing of video data. For any given combination of operations to be performed, the data transfers to be performed to support those operations are determined by the application program. The application program then allocates the appropriate buffers, and programs the DMA contexts for each channel and BCUs for each buffer. After setting up the DMA operations and the buffers, the data can be processed. Once the application initiates the data flow, no further intervention is required by the application or host processor in order for the data to be routed to its destination, and processed through the intermediate steps. Moreover, the DMA and BCU controllers impose an autonomous flow control mechanism that ensures that data is sequenced properly through the processing steps without further attention from the application program, and with a minimum of latency-based delays.

More details of an example implementation of the DMA controller, DMA context information, buffer control units, memory arbiter and read and write data buffers will now be provided in connection with FIGS. 4 through 7.

FIG. 4 is a more detailed block diagram of an example implementation of the DMA controller with the write data path. Data flows from an input port into the input port's FIFO 400. In 8-bit mode, incoming bytes are paired and written into a 16-bit-wide FIFO location; in 10-bit mode (or greater) each incoming component is written into a 16-bit location in the FIFO. (In another implementation, non-byte-width data could be packed into 16-bit words to optimize storage and memory bandwidth). Each port has associated counters and control logic 401. The counters and control logic may use information from the DMA controller 414 about a transfer to format data being written to the memory system 411 from the port. For example, the port may add intra-word padding to correctly align the data elements. Each byte within the word has a flag bit that indicates whether the byte is valid and should be written to memory. Thus, all “byte” widths are actually 9 bits, and the width of the write path is actually 72 bits.

When 8 bytes of the port FIFO 400 are filled, the data is written as a single 64-bit word into registers 403 for that channel in the word assembly register/multiplexer 402. The writing of different data streams by different channels into the multiplexer 402 is controlled by arbiter 405. The arbiter 405 may permit writing on a round robin basis or by using any other suitable arbitration technique, such as by assigning priorities to different channels. As a word is written to the registers for a channel in this multiplexer 402, a 2-bit counter 404 associated with that channel is incremented. When four 64-bit words have been written to a port's assembly area 403 in the multiplexer, the data is transferred to a burst assembly buffer 408 as a single 256-bit word, through one or more intermediate FIFOs. It may be desirable to force each channel to always transfer a group of four 64-bit words. Each channel has its own designated address range in the burst assembly buffer. There is a 5-bit counter 410 associated with each port's designated address range within the burst assembly buffer 408. This counter is used to track the amount of data currently in the buffers for that channel. After up to sixteen 256-bit words (512 bytes) have been written into one of the buffers defined for a given channel in the burst assembly buffer, as determined by counter 410, a burst of up to 512 bytes may be written into the memory system 411.

An arbiter 412 determines whether such a burst transfer to the memory system should be made for a channel. The arbiter can make such a determination in any of a number of ways, including, but not limited to, round robin polling of the counter of each channel, or by responding to the counter status as if it were an interrupt, or by any other suitable prioritization scheme. Certain channels may be designated as high priority channels which are processed using interrupts (such as for live video data capture), whereas other channels for which data flow may be delayed can be processed using a round robin arbitration. The buffer status is checked as data is transferred in or out of the buffer to determine if a request is warranted.

The requests from the arbiter are queued to the DMA controller 414 through one or more FIFOs. An integral arbiter within the DMA controller determines which of the (potentially many) requests it will service next. The DMA controller loads the appropriate parameters for the transfer from the DMA context RAM block 416 (CRB). Using this information, the buffer control unit 419 linked to the buffer for the transfer also is accessed and checked.

The contents of the DMA Context RAM block 416 and the buffer control unit 419 will now be described in more detail.

The DMA context RAM block is a memory that is divided into a number of units, where each unit is assigned to a DMA channel. Each unit may include one or more memory locations, for example, about 16 memory locations. Each memory location is referred to as a DMA context block (DCB). For example, if there are 64 DMA channels, and 16 DCBs per channel, there would be 1024 memory locations. One DCB per channel may be designated as the active or scratchpad DCB, which is the DCB that is loaded for that channel to perform a data transfer. The DCBs for each channel may be linked together such that by use of one set of parameters from a DCB, the next set of parameters from the next DCB for that channel are automatically loaded into the location for the current DCB. Additionally, the active DCB may be modified by the DMA controller if, for example, the DMA performs only a partial data transfer.

Each DCB includes a set of parameters that are programmable by the application program running on the host computer. The set of parameters are stored in a set of registers that hold control information used by the DMA controller to effect a data transfer. These parameters generally include an address for the data transfer and a transfer count (i.e., an amount of data to be transferred). A pointer or link to the next set of parameters for the channel also may be provided. All DCBs except the active DCB for a channel are programmable by the application program. In the active DCB, only the link (to the next set of parameters) should be programmed by the application program.

An example of the kinds of data that may be stored in an example set of registers in a DCB in one embodiment may include the following:
1. A DMA operations register may include a “chain pointer” (which is the link to the next DCB for the channel), a DMA control register (which may represent data format information and other control information), and a BCU pointer (which indicates the BCU associated with the buffer involved in the transfer). The control information may include, for example, flags indicating that an interrupt should be generated when the transfer is complete or that the DMA engine should not yet start the transfer. Another useful control is a flag that forces a BCU to indicate that it is available to read or write data after a data transfer, even if that data transfer does not use a complete buffer slice. Other useful information that may be placed in this DMA operations register includes a BCU sequence increment bit and a BCU sequence number which permits multiple channels to access the same buffer and BCU, but controls the order in which these channels may access the BCU, as described below.
2. A start address register may include the address in the memory system of the next data block to be transferred. This start address may be updated in the active DCB as the DMA operation proceeds. Ideally, this address should point to a burst-aligned memory location for best performance.
3. A transfer count register may include information from which a transfer count may be derived. For example, when video and audio data is being used, some programmable characteristics of the audio and video data also may be provided by additional registers in a DCB. For example, a line length/number of lines register may be used to represent the size of image data in a rectangular format. For rectangular image data, the initial line length (as indicated in an Initial Line Length register) should be the same as the line length, but the two may differ for transfers of data (such as compressed video data) of any length. A pad register may be used to represent the number of 32-bit words between the end of one line and the beginning of the next. One application of such a pad register is to extract only even lines or only odd lines of video from a buffer of image data.

A DCB also may include information not used by the DMA controller but used by the port that is transferring data. This information may include, for example, data format information and control parameters for processing performed by the port, such as audio mixing settings. A separate memory may be provided for this additional port information. As noted below, such information could be used by any port that is reading or writing data. A client control bus 430 is provided to connect the DMA controller to all of the ports. The port information for a transfer may be sent over the bus 430 to the appropriate port. In one embodiment, bus 430 is a broadcast channel and port information is sent, preceded by a signal indicating the port for which the information is intended. There are numerous other ways to direct port information to the ports in the system.

As noted above, the memory system is dynamically organized into buffers by the application software. Each buffer is a region of memory, and may be used, for example, as temporary data storage between processing elements that are connected to the read and write channels. The size and many characteristics of each buffer are programmable as noted above. A buffer has associated with it one or more buffer control unit entries (BCU entries). The BCU is the mechanism which controls the flow of data through the memory buffer, allowing the memory to be used as a FIFO with variable latency. Multiple BCU entries may be specified by the application at any given time. The BCU for a buffer tracks the amount of data written to and read from the buffer, counting the data in units called “slices”. A slice defines the granularity that the system uses to manage the buffers. The size of a slice is programmable within each BCU. For example, a slice may be a number of video lines, from 1 to 4096, or a number of supersamples (512 byte blocks) of audio data. The size of a given buffer is defined as the number of slices that the buffer can hold. A suitable limit for this size may be 4096 slices. If the size of a video line is also programmable, these parameters are programmed with significant flexibility.

As an independent logical unit, the BCU is a resource which can be assigned to any of the DMA channels. As noted above, the DCB for a DMA channel references a specific buffer in the memory system (as defined by the transfer address) and includes a BCU pointer to identify the BCU associated with the buffer. The BCU keeps track of the number of slices in the buffer (0 to 4095), providing a full flag to stall the port-to-memory DMA channel and an empty flag to stall the memory-to-port DMA channel. Thus a buffer may be “filled” by one DMA channel and the DMA channel reassigned to other tasks using other buffers, and the BCU retains the “status” of the buffer until another DMA channel links to it in order to access the data in the buffer. The BCU function is used when an access to the memory system is requested. The BCU either allows or disables the memory access, depending on the “fullness” of the buffer that is being accessed. Thus, an implementation may use only one physical BCU, which changes context for every memory access. Those contexts may be stored in four 512×32 RAMs yielding 512 individual contexts. When a DMA channel attempts to access the memory system, the BCU pointer in the DMA channel's current DCB selects the BCU context for that channel. Application software assigns the BCU pointer to the channel when programming the DCB.

Thus, each entry or context in the BCU context RAM block generally includes state information, such as current read and write pointers and the buffer size, to permit the determination of the fullness of the buffer. In one embodiment using the concept of “slices” noted above, a BCU may include a read line count, a write line count, a buffer size, a slice size, a slice count, a sequence count and other control information. These parameters for the BCU are programmed by the application when the BCU is allocated to a specific buffer. The read line count and write line count represent the number of lines that have been read from or written to the next slice, respectively. The slice size parameter defines how many lines are in a slice, and the slice count indicates the number of valid slices in the buffer at any given moment. Slices are defined in terms of lines of video in order to place reasonable limits on the hardware resources required to implement these functions; finer granularity in the flow control may be achieved by defining the slices in terms of smaller units (for example, pixels or bytes), at the expense of providing larger counters and comparators.

The sequence count field is another way in which DCBs for a channel and a BCU entry for a buffer interact. The sequence count field may be used for buffer read or write operations, to allow for the synchronization of multiple sets of DMA engines using the same buffer. This field may be ignored for read operations in certain implementations. As noted above, a DCB for a DMA operation includes a sequence number as well as a BCU pointer. If the sequence number in the DCB does not match the sequence count in the BCU, then the DMA engine will not transfer data, just as if the BCU was reporting that the buffer was full or empty. The sequence count may be optionally incremented at the end of the execution of any given DCB by setting the BCU sequence increment bit in that DCB.

The control field may include any control bits for functions available in the DMA engine. For example, these functions may include stop, go, write link and read link. The stop and go bits allow for direct host control so that the application may pause a transfer (by setting the stop bit) or allow a transfer to free-run (by setting the go bit).

The write link and read link operations are used to permit multiple ports to access the same buffer. For example, a video channel and an alpha channel may be merged into the same buffer, but data should not be read out of the buffer until both input channels have written into the channel. To support this operation, multiple BCU contexts may be linked using the read link and write link control bits in the BCU mentioned above. Linked contexts reside in consecutive locations in the BCU Context RAM. For example, DMA channel A, writing video to the buffer, is programmed to use BCU Context 30. BCU context 30 would have its read link bit set. DMA channel B, writing alpha to the buffer, is programmed to use BCU Context 31. Each DMA channel's write access to the buffer is independently controlled. The buffer read is performed by DMA channel C, whose DCB is set to use BCU Context 30 (an implementation would set a convention as to whether the lowest-numbered or highest-number linked context is to be used). When BCU Context 30 is accessed for the Read operation, because the read link bit is set, the buffer status is checked, and then the next Context (31) is also read and checked. Only if both level checks pass is the read memory access allowed to proceed. To link multiple buffer read operations, the same sequence applies, but the write link bit is set in each context that has a subsequent link.

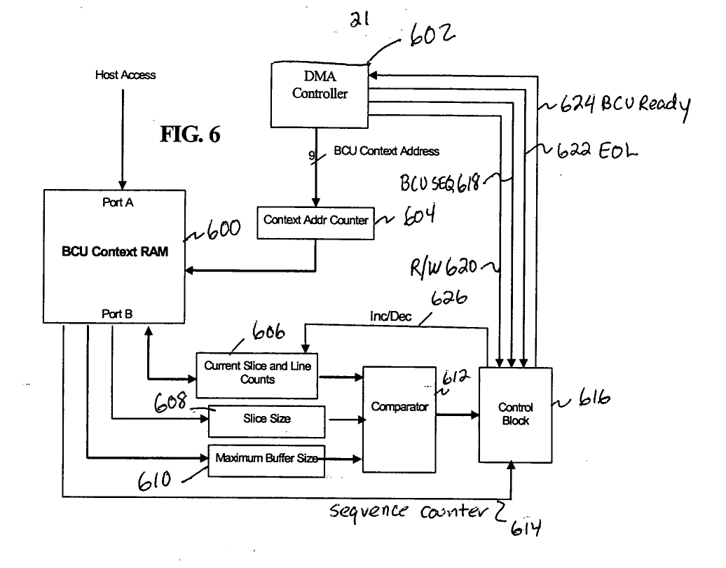

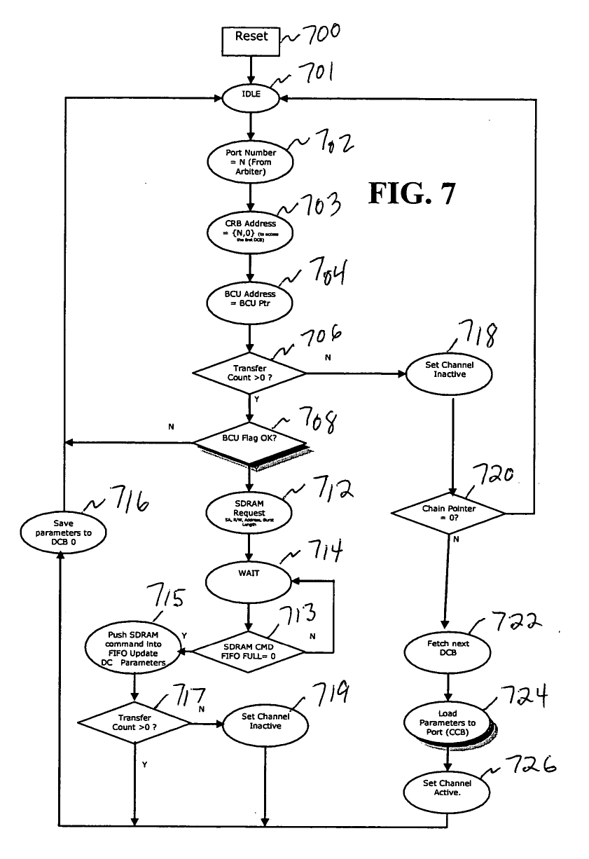

Given the parameters for the channel from the current DCB for the channel, the DMA controller effects the data transfer using the state information about the buffer from the BCU controller 418 and BCU context RAM block 419, in a manner described below in connection with FIGS. 6 and 7. After the data transfer is performed, the BCU controller is informed, so that the state information stored in the BCU context RAM block 420 about the buffer is updated. Also, the DMA controller updates the parameters for the channel in the DMA context RAM block 416 by either updating the active DCB or by loading another DCB for the channel into the active DCB.

FIG. 5 is a more detailed block diagram of the DMA controller with the read data paths. The read data paths are similar to the write data paths except the data valid bits used in the write data paths may be omitted in the read data paths. Although shown in both FIGS. 4 and 5, the DMA engine, BCU controller, CRB, BCU and memory are not duplicated for the read path. However, there are independent arbiters for the read and write data paths. The DMA engine 500 is informed by an arbiter 501 which channel is ready for transferring data from the memory 502 to a burst disassembly buffer 504. The arbiter may operate on a round robin basis or any other suitable basis, such as by assigning priorities to different channels, to service requests for data that may be pending from a client port, e.g., 506. Up to a fixed number of bytes, such as 512 bytes, are transferred in a burst to the burst disassembly buffer. For example, the SDRAM controller may handle groups of 4 256-bit words (up to 16), the BAB/BDB can then refine the granularity to individual 256-bit words, and the individual clients can then further refine the granularity to individual 32-bit words. The DMA controller loads the appropriate parameters for the transfer from the DMA context RAM block 508 and effects the data transfer using the state information 512 about the buffer through the BCU controller 510, in a manner described below in connection with FIGS. 6 and 7. After the data transfer is performed, the BCU controller is informed so that the state information about the buffer may be updated in the BCU context RAM block 512. The DMA controller also updates the active DCB.

There is a 5-bit counter 514 associated with each port's designated address range within the burst disassembly buffer 504. After up to sixteen 256-bit words (512 bytes) have been written into the address range for a channel in the burst disassembly buffer 504, that data may be read out through disassembly buffers 516 to the appropriate channel. An arbiter 520 controls which channel is reading from the burst disassembly buffer 504 into its corresponding buffer, from which data is transferred to its corresponding channel. This arbiter may operate, for example, on a round robin basis, or other suitable scheme, such as by assigning different priorities to different channels. The disassembly buffers 516 receive and store each 256-bit word in a FIFO memory for a channel as indicated at 526. A counter 528 for each channel determines when the FIFO is full or empty. Data in the FIFO is transferred to the client port 506 in 4 consecutive 64-bit chunks. The transferred data may be subjected to appropriate padding and formatting (indicated at 522) to the FIFO 524 at the client port 506. Similar to write operations, the DMA controller also may send information about the transfer to the port that is reading the data over the client control bus 530 to be used by the counter and control logic 532.

FIG. 6 is a block diagram of an example implementation of the BCU controller and BCU context RAM that illustrates how the BCUs are used and updated for a data transfer. The BCU context RAM 600 stores the BCU entries. This RAM may be implemented as a dual port RAM. The host accesses the BCU context RAM 600 to program the BCUs. The DMA engine 602 provides a BCU context address 604 to access the BCU for the buffer to be accessed. In response, the BCU context RAM 600 provides the current slice and line counts 606, the slice size 608 and the maximum buffer size 610 to a comparator 612. It also provides the sequence counter 614 to a control block 616. The result of the comparator 612 is provided to the control block 616. The comparator indicates whether the buffer to which the BCU is attached is ready for reading or writing. In essence, it performs a “level check” and provides “full” (for write) or “empty” (for read) flags, allowing the buffer to be treated as a FIFO with programmable characteristics. The control block 616 also receives the BCU sequence count 618 (based on the DCB for the current transfer), a read/write flag 620 indicating whether the transfer is a read operation or a write operation, and an end-of-line flag 622 from the DMA engine. The control block then provides a BCU ready flag 624 to the DMA engine and an increment or decrement flag to update the BCU values. The increment/decrement flag is based on the end of line flag from the DMA controller. The updated BCU values then are written back to the BCU context RAM.

FIG. 7 is an implementation diagram of a state machine describing how the DMA engine may operate. Upon reset of the system (700), the DMA controller is in an idle state (701), until the arbiter indicates that a transfer should occur. The arbiter indicates (702) the port number (N) for which the transfer is to be performed. For example, a round robin approach to arbitration of access to the memory may be used, or some other scheme such as by assigning different priorities to different channels or groups of channels. The active DMA context block (DCB 0) for port N is loaded from the CRB (702). The BCU pointer is read from DCB 0 to obtain the address of the BCU for the buffer involved in this tranfer. It is then determined (706) whether the transfer count for the transfer is greater than zero. If the transfer count is greater than zero, the BCU flag for the designated buffer is then checked (708). If the BCU flag indicates that a data transfer can occur, the DMA controller generates (712) a request to the memory controller to transfer the data, identifying the address in the memory (SA), the address in the read or write buffer, the number of bursts of data to be sent to or received from the burst buffer, and whether the operation to be performed is a read or a write. The DMA controller then enters a wait state (714). In particular, if the command FIFO of the memory controller is full (as indicated at 713), the DMA controller waits until it is not full. When the command FIFO of the memory controller is not full, the DMA controller may push the generated SDRAM command into the memory controller command FIFO, as indicated at 715. The DCB parameters then are updated. In particular, the number of bursts of data for the transfer that was just performed is used to update the address and the transfer count of the DCB. If the remaining transfer count is not greater than zero, as indicated at 717, the channel is set to inactive (719). If the transfer count is greater than zero, as indicated at 717, or after a channel is set to inactive, the updated parameters are saved (716) to the DCB 0 location for this channel and the DMA controller returns to the idle state 701.

If, in step 706, the transfer count is not greater than zero, then the current channel N is set (718) to be inactive. If the chain pointer in the active DCB is equal to zero, as determined in step 720, then the current port has no further operations to process, and the DMA controller returns to the idle state 701. Otherwise, the next DCB for the channel is fetched (722) using the chain pointer. Any port-specific parameters for the current port N are then sent (724) to that port, and the channel is set (726) to be active. The first set of the transfer parameters is then saved into the DCB 0 location in step 716, and the DMA controller returns to the idle state 701.

In one embodiment, the DMA system described herein may be a peripheral device to a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

The computer system may be a general purpose computer system which is programmable using a computer programming language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. A memory system in such a computer system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program.

One or more output devices may be connected to such a computer system. Example output devices include, but are not limited to, a cathode ray tube display, liquid crystal displays and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

Having now described a few embodiments, it should be apparent to those skilled in the art that the foregoing is merely illustrative and not limiting, having been presented by way of example only. Numerous modifications and other embodiments are within the scope of the invention.

1. A context based direct memory access architecture, comprising:
a memory;
a plurality of ports, wherein each port has an associated buffer for temporarily storing data transferred through the port, and wherein each port has an associated direct memory access channel;
a direct memory access controller that receives requests for accessing the memory by the plurality of ports, wherein each request is received from one of the plurality of ports, and wherein the direct memory access controller stores parameters defining the direct memory access operations for each port, and wherein after a request is received from a port the direct memory access controller loads the parameters for the current direct memory access operation for the port to enable the port to access the memory.

2. The context based DMA of claim 1, further comprising a central parameter store for storing parameters for each of a plurality of DMA channels corresponding to each of the plurality of ports.

3. The context based DMA of claim 2, wherein the direct memory access controller further comprises means for servicing the request, comprising:
means for queuing a memory operation;
means for updating parameters; and
means for fetching and storing parameters in the central parameter store.

4. An apparatus for communicating data among devices interconnected by a memory, comprising;
a single DMA controller;
in the first device, means for writing data to the memory using the DMA controller;
in the second device, means for reading data from the memory using the DMA controller;
wherein the DMA controller receives information from a DMA context memory specifying parameters for writing data from the first device to the memory and wherein the DMA controller receives information from the DMA context memory specifying parameters for reading data from the memory to the second device.

5. The apparatus of claim 4, further comprising:
a buffer control unit for communicating to the DMA controller an indication of an amount of data written into the memory by the first device through the DMA controller and for communicating to the DMA controller an indication of the amount of data read from the memory by the second device through the DMA controller; and
wherein the DMA controller reads data from the memory for the second device if data is available as determined by the indicated amount of data written to the memory and the amount of data read from the memory as communicated by the buffer control unit.

6. The apparatus of claim 4, further comprising:
a buffer control unit for communicating to the DMA controller an indication of an amount of data written into the memory by the first device through the DMA controller and for communicating to the DMA controller an indication of the amount of data read from the memory by the second device through the DMA controller; and
wherein the DMA controller writes data to the memory for the first device if memory space is available as determined by the indicated amount of data written to the memory and the amount of data read from the memory as communicated by the buffer control unit.
